(19) United States
(12) Patent Application Publication
(10) Pub. No.: US 2012/0228939 A1
(43) Pub. Date: Sep. 13, 2012

(54) POWER SUPPLY METHOD, A RECORDING MEDIUM WHICH IS COMPUTER READABLE AND A POWER GENERATION SYSTEM

(75) Inventors: Yoshito KAGA, Moriguchi-shi (JP); Hiroyuki OKUDA, Moriguchi-shi (JP); Atsuhiro FUNAHASHI, Moriguchi-shi (JP); Takeshi NAKASHIMA, Moriguchi-shi (JP); Souichi SAKAI, Moriguchi-shi (JP); Ryuzo HAGIHARA, Moriguchi-shi (JP)

(73) Assignee: SANYO ELECTRIC CO., LTD., Moriguchi-shi (JP)

(21) Appl. No.: 13/414,517

(22) Filed: Mar. 7, 2012

Related U.S. Application Data
(63) Continuation of application No. PCT/JP2010/072969, filed on Dec. 21, 2010.

(30) Foreign Application Priority Data
Dec. 24, 2009 (JP) 2009-292302

(51) Int. Cl. H02J 1/00

(52) U.S. Cl. 307/43

(57) ABSTRACT

A method of controlling a battery storing electric power generated by a power generator generating electric power using renewable energy, comprising: computing a output value for the electric power to be supplied to an electric power transmission system based on a predetermined maximum charge rate of the battery, and a predetermined maximum discharge rate for the battery; and supplying to the electric power transmission system with electric power corresponding to the output value from at least one of the power generator and the battery.

This application is a continuation of International Application No. PCT/JP2010/072969, filed Dec. 21, 2010, which claims priority from Japanese Patent Application No. 2009-292302, filed Dec. 24, 2009, the entire contents of which are incorporated herein by reference.

### TECHNICAL FIELD

The present invention relates to a power supply method, a recording medium which is readable by a computer and a power generation system.

In recent years the number of instances where electricity consumers (e.g. domestic houses or factories and the like) in receipt of the supply of alternating current from substations are supplied with power generators utilizing natural energy such as wind power and sunlight (solar cells) is increasing. These types of power generators are connected to the power grid subordinated to the substation, and power generated by the power generators is output to the power consuming devices side of the consumer location. The superfluous electric power, which is not consumed by the power consuming devices in the consumer location, is output to the power grid. The flow of this power towards the power grid from the consumer location is termed “counter-current flow”, and the power output from the consumer to the power grid is termed “counter-current power”.

In this situation the power suppliers such as the power companies and the like have a duty to ensure the stable supply of electric power and need to maintain the stability of the frequency and voltage of the overall power grid, including the counter-current power components. For example, the power supply companies maintain the stability of the frequency of the overall power grid by a variety of methods in correspondence with the size of the variable period. Specifically, in general, in respect of a load component with a variable period of some tens of minutes, economic dispatching control (EDC) is performed to enable output sharing of the generation amount in the most economic manner. This EDC is controlled based on the daily load fluctuation expectation, and it is difficult to respond to the increases and decreases in the load fluctuation from minute to minute and second to second (the components of the fluctuation period which are less than some tens of minutes). In that instance, the power companies adjust the amount of power supplied to the power grid in correspondence with the minute fluctuations in the load, and perform plural controls in order to stabilize the frequency. Other than EDC, these controls are called frequency controls, in particular, and the adjustments of the load fluctuation components not enabled by the adjustments of the EDC are enabled by these frequency controls.

More specifically, for the components with a fluctuation period of less than approximately 10 seconds, their absorption is enabled naturally by the auto-control function of the power grid itself. Moreover, for the components with a fluctuation period of less than 10 seconds to the order of several minutes, they can be dealt with by the governor-free operation of the power generators in each generating station. Furthermore, for the components with a fluctuation period of the order of several minutes to tens of minutes, they can be dealt-with by load frequency control (LFC). In this load frequency control, the frequency control is performed by the adjustment of the generated power output of the generating station for LFC by a control signal from the central power supply command station of the power supplier.

However, the output power of power generators utilizing natural energy may vary abruptly in correspondence with the weather and such like. This abrupt fluctuation in the power output of this type of power generator applies a gross adverse impact on the degree of stability of the frequency of the power grid they are connected to. This adverse impact becomes more pronounced as the number of consumers with power generators using natural energy increases. As a result, in the event that the number of consumers with power generators utilizing natural energy increases even further henceforth, there will be a need arising for sustenance of the stability of the power grid by the control of the abrupt fluctuation in the output of the power generators.

In relation to that, there have been proposals, conventionally, to provide the power generation systems with batteries to enable the storage of power resulting from the power generated by power generators, in addition to the power generators utilizing natural energy, in order to control the abrupt fluctuation in the power output of these types of power generators. Such a power generation system was disclosed, for example, in Japanese laid-open patent publication No. H2008-295208.

In Japanese laid-open patent publication No. H2008-295208, there is the disclosure of power generation system provided with a dispersed power source such as wind mills (power generators), and the battery enabling storage of the power generated by the dispersed power sources. In the patent publication, by controlling, the performance of the charge and discharge of the batteries in accordance with the fluctuation of the power output of the dispersed power sources, the output to the power grid is smoothed. By this means, because the adverse impact of the frequencies and the like on the power grid can be suppressed. Moreover, in the power generation system enabled by the patent publication, when the smoothing of the output to the power grid is performed, the control of the charging and discharging of the batteries is performed so as to enable a charged state of 50% of the batteries. In other words, when the charged state is greater than 50%, smoothing is performed while performing charging and discharging such that the charged state of the batteries is reduced, and when the charged state is less than 50%, smoothing is performed while performing charging and discharging such that the charged state of the batteries is increased.

### PRIOR ART TECHNOLOGY REFERENCES

### Patent References

Patent Reference No. 1: Japanese laid-open patent publication No. H2008-295208.

### OUTLINE OF THE PATENT

### Problems to be Solved by the Invention

In the patent publication, because the value of the target charged state is fixed at 50%, there is the problem that the performance of smoothing while effectively utilizing the charge and discharge capacity of the battery is difficult. In other words, normally, because the amount of power which can be charged at one time is less than the amount of power which can be discharged at one time in the battery, when the charged state is 50%, while the reserve power required to perform charge and discharge from that charged state is great on the one hand, the discharge reserve power is very small. In this situation, when smoothing is performed, during the discharge, when there is a lot of electrical discharge required, the charged state of the battery goes to 0%, and not only is it difficult to perform smoothing, the effective utilization of the charge and discharge capacity of the battery is not possible.

### SUMMARY OF THE INVENTION

The method of controlling a battery storing electric power generated by a power generator generating electric power using renewable energy, comprising: computing a output value for the electric power to be supplied to an electric power transmission system based on a predetermined maximum charge rate of the battery, and a predetermined maximum discharge rate for the battery; and supplying to the electric power transmission system with electric power corresponding to the output value from at least one of the power generator and the battery.

The computer-readable recording medium which records a control programs for causing one or more computers to perform the steps comprising: computing a continuous charging time at a certain time based on a predetermined maximum charge rate of the battery, the continuous charging time, is the time required to maximally charge the battery at the maximum charging rate, computing a continuous discharging time at the certain time based on a predetermined maximum discharge rate of the battery, the continuous discharging time is the time required to maximally discharge the battery at the maximum discharging rate, computing a output value for the electric power to be supplied to an electric power transmission system, the output value is determined so that the continuous charging time and the continuous discharging time are substantially equalized, and supplying to the electric power transmission system with electric power corresponding to the output value from at least one of the power generator and the battery.

The electric power generation system, comprising: a power generator configured to generate electric power using renewable energy; a battery configured to store electric power generated by the power generator; and a controller configured to compute a output value for the electric power to be supplied to an electric power transmission system based on a predetermined maximum charge rate of the battery, and a predetermined maximum discharge rate for the battery, [[(ii)]] to supply to the electric power transmission system with electric power corresponding to the output value from at least one of the power generator and the battery.

The electric power generation system, comprising: a power generator configured to generate electric power using renewable energy; a battery configured to store electric power generated by the power generator; a commutation section configured to compute a output value for the electric power to be supplied to an electric power transmission system based on a predetermined maximum charge rate of the battery, and a predetermined maximum discharge rate for the battery; and a supply section configured to supply to the electric power transmission system with electric power corresponding to the output value from at least one of the power generator and the battery.

The device controlling a battery storing electric power generated by a power generator generating electric power using renewable energy, comprising: a controller configured to [[(i)]] compute a output value for the electric power to be supplied to an electric power transmission system based on a predetermined maximum charge rate of the battery, and a predetermined maximum discharge rate for the battery, [[(ii)]] to supply to the electric power transmission system with electric power corresponding to the output value from at least one of the power generator and the battery.

### BRIEF DESCRIPTION OF THE DRAWINGS

FIG. 1 shows a block diagram of the configuration of the power generation system of the present invention.

FIG. 2 shows a graph in order to explain the computation method the first target value of the battery of the power generation system of the first embodiment of the present invention.

FIG. 3 shows a diagram in order to explain the computation method the first target output value of the battery of the power generation system of the first embodiment of the present invention.

FIG. 4 shows a diagram in order to explain fluctuation period and the relationship of the size of the fluctuation in the load output to the power grid.

FIG. 5 shows a flow chart in order to explain the flow of the charge and discharge control of the power generation system of the first embodiment of the present invention.

FIG. 6 shows a drawing in order to explain the sampling period in the charge and discharge control.

FIG. 7 shows a diagram in order to explain the acquisition period of the power output data in order to compute the first target output value of the power output in the charge and discharge control of the power generation system of the second embodiment of the present invention.

FIG. 8 shows a diagram in order to explain the trends of the power output data and the first target output value in the initial period of the charge and discharge control of the power generation system of the second embodiment of the present invention.

FIG. 9 is a drawing showing the FFT analysis results in order to prove the alleviation effect of the adverse effects on the power grid of the power generation system of the second embodiment of the present invention as a result of the performance of charge and discharge control.

FIG. 10 shows a graph of the results of a simulation of the time trends of the fluctuation in the output current by the power generation device, and the time trends of the fluctuation in the output current when smoothing is performed on this output current using the control of the first embodiment, and the time trends of the fluctuation in the output current when smoothing is performed by the moving average method only.

FIG. 11 is a graph showing the fluctuation trends over time of the charged state of the battery cell corresponding to FIG. 10.

FIG. 12 is a graph showing the results of the fast Fourier transform of the output current corresponding to FIG. 10.

FIG. 13 shows a graph of the results of a simulation of a different time trends to that of FIG. 10 of the fluctuation in the output power by the power generator, and the time trends of the fluctuation in the output current when smoothing is performed on this output current using the control of the first embodiment, and the time trends of the fluctuation in the output current when smoothing is performed by the moving average method only.

FIG. 14 is a graph showing the fluctuation trends over time of the charged state of the battery cell corresponding to FIG. 13.

FIG. 15 is a graph showing the results of the fast Fourier transform of the output current corresponding to FIG. 13.

FIG. 16 shows a graph of the results of a simulation of the time trends of the power output generated by the same power output device as in FIG. 13, and the time trends of the fluctuation in the output current when smoothing is performed on this output current using the control of the second embodiment, and the time trends of the fluctuation in the output current when smoothing is performed by the moving average method only.

FIG. 17 is a graph showing fluctuation trends over time of the charged state of the battery cell corresponding to FIG. 16.

FIG. 18 is a graph showing the results of the fast Fourier transform of the output current corresponding to FIG. 16.

### BEST METHODS OF EMBODYING THE INVENTION

Hereafter, the embodiments of the present invention are explained based on the figures.

### The First Embodiment

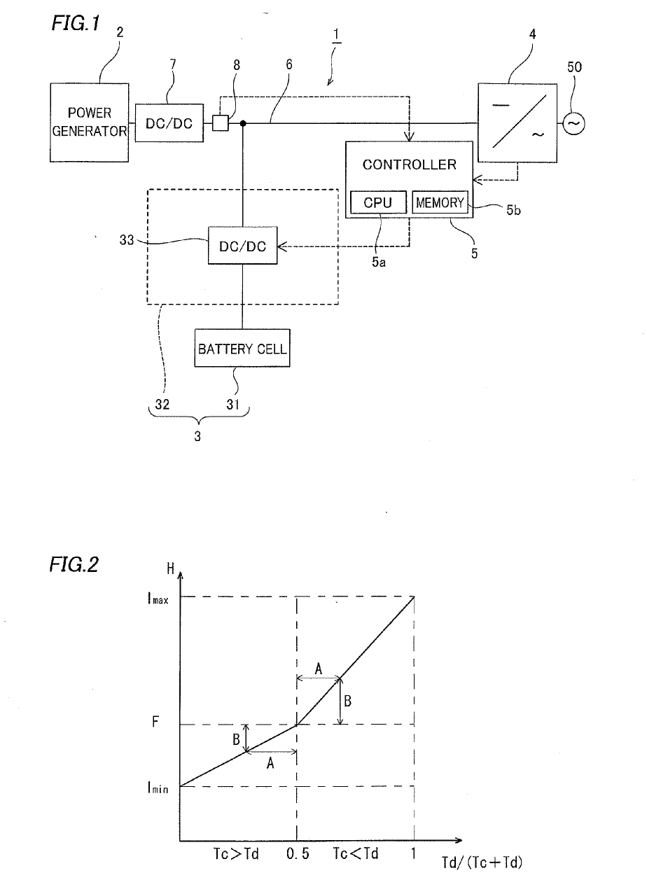

Firstly, the configuration of the power generation system 1 is explained by the first embodiment of the present invention while referring to FIG. 1 to FIG. 4.

The power generation system 1 has the power generator 2 comprised of a solar cell employing sunlight, connected to the power grid 50. The power generation system 1 provides the battery 3 enabling electrical storage of the power generated by the power generator 2, and the supply section 4 including an inverter which outputs electrical power stored by the battery 3 as well as power generated by the power generator 2 to the power grid 50, and the charge and discharge controller 5 controlling the charging and discharging of the battery 3. Now, the power generator 2 is preferably a generator utilizing renewable energy and, for example, may employ a wind power generator and the like.

The DC-DC converter 7 is connected in series on the bus 6 connecting the power generator 2 and the supply section 4. The DC-DC converter 7 converts the direct current voltage of the power generated by the power generator 2 to a fixed direct current voltage (In this embodiment, approximately 260 V) and outputs to the supply section 4 side. Moreover, the DC-DC converter 7 has a so-called a maximum power point tracking (MPPT) control function. The MPPT function is a function where by the operating voltage of the power generator 2 is automatically adjusted to be maximized in the power generated by the power generator 2. A diode is provided (not shown in the figures) between the power generator 2 and the DC-DC converter 7 so as to prevent the reverse flow of the current to the power generator 2.

The battery 3 includes the battery cell 31 connected in parallel with the bus 6, and the charge and discharge means 32 which performs the charge and discharge of the battery cell 31.

As the battery cell 31, a high charge and discharge efficiency ratio rechargeable battery with low natural discharge (e.g. a lithium ion battery cell, a Ni—MH battery cell and the like) are employed. Moreover, the voltage of the battery cell 31 is approximately 48 V. Furthermore, the maximum charge rate and the maximum discharge rate are mutually different values, and the maximum charge rate is less than the maximum discharge rate. For example, in embodiment 1, the maximum charge rate and the maximum discharge rate of the battery cell 31 are, respectively, 1It and 4It. Here, the maximum charge rate and the maximum discharge rate means the values which the user or the suppliers sets freely in order to suppress any excess load on the battery cell 31 by high velocity charging or discharging, and is the maximum value for the charge current and the discharge current of the battery cell 31.

The charge and discharge means 32 has a DC-DC converter 33, and the bus 6 and the battery cell 31 are connected via the DC-DC converter 33. When charging, the DC-DC converter 33 supplies power from the bus 6 side to the battery cell 31 side by reducing the voltage of the bus 6 to a voltage suitable for charging the battery cell 31. Moreover, when discharging, the DC-DC converter 33 discharges the electrical power from the battery cell 31 side to the bus 6 side by raising the voltage from the voltage of the battery cell 31 to the vicinity of the voltage of the bus 6 side.

The controller 5 includes CPU 5a and memory 5b, and performs the control of the charge and discharge of the battery cell 31 by controlling the DC-DC converter 33. The charge and discharge control of the battery cell 31 is performed by making CPU 5a perform the control program recorded in the memory 5b. The control program is recorded in a recording media which is computer readable. The control program read-out from the recording media is installed in the memory 5b of the charge and discharge controller 5.

In this embodiment, a target output value is set for output to the power grid 50, in order to smooth the power value output to the power grid 50, irrespective of the amount of power generation by the power generator 2. The controller 5, controls the amount of the charge and discharge of the battery cell 31, in order that the amount of power output to the power grid 50 becomes the target output value, in accordance with the amount of power generation by the power generator 2. In other words, when the amount of the power generation by the power generator 2 is in excess of the target output value, the controller 5 not only controls the DC-DC converter 33 in order to charge the battery cell 31 using the excess power, but also when the amount of power generated by the power generator 2 is less than the target output value, the controller 5 controls the DC-DC converter 33 in order discharge the shortfall from the battery cell 31.

Moreover, the controller 5 acquires the power output data from the detector 8 provided on the output side of DC-DC converter 7. The detector 8 detects the power generation of the power generator 2 and transmits the power output data to the controller 5. The controller 5 acquires the power output data from the detector 8 at specific detection time intervals (e.g. less than 30 seconds). Here, in order that the fluctuation period be shorter than that which the load frequency control can deal with, the power output data is acquired every second. Now if the detection time interval of the power output data is too long or too short, the fluctuation in the power output cannot be detected accurately, it is set at an appropriate value in consideration of the fluctuation period of the power output of the generator 2.

Moreover, the target output value to the power grid 50 is computed by the controller 5 using the moving average method. The moving average method is a computation method for the target output value for a point in time, wherein the average value for the amount of power generated by the power generator 2 in a period from the point in time back to the past is computed. Hereafter, the period used in order to acquire power output data to use in the computation of the target output value is called the sampling period. The sampling period is preferably a period between the fluctuation periods T1 (approximately 2 minutes) and T2 (approximately 20 minutes), in correspondence with the load frequency control (LFC), preferably greater than the lower limit period T1 and in the latter half (the longer period area) and should not be a period which is too long. Here, because the controller 5 uses power output data of the power generator 2 every second to compute the target output value, the target output value is computed by computing the mean value of plural previous power output data (e.g. 120˜1200) from each second. The upper limit period T1 and the lower limit period T2 will be described in detail later.

Moreover, the controller 5 not only acquires the power output value of the supply section 4, it determines the difference between the power output value, actually output to the power grid 50, and the target output value, and feedback controls the charge and discharge means 32 such that the actual output value from the supply section 4 is the target output value.

Moreover, the controller 5 detects the state of charge (SOC) of the battery cell 31. The SOC is 0% when the power storage value is 0, and 100% when the power storage value is 1 and fully charged.

Next, an explanation is provided of the method of the charge and discharge control of the battery cell 31 by the controller 5.

As described above, the controller 5 controls the charge and discharge of the battery cell 31 such that the sum of the power output of the power generator 2 and the charge and discharge amount of the battery cell 31 is the target output value. However, depending on the power storage state of the battery cell 31, there are times when it is difficult to reach the target output value. For this reason, the controller 5 does not use the target output value computed by the moving averages method (Hereafter, called the ‘the first target output value’) in itself, but a target output value which incorporates a correction computed in consideration of the state of charge of the battery cell 31 into the first target output value (Hereafter, called the ‘the second target output value’), and controls the charging and discharging of the battery cell 31 such that this second target output value is output from the supply section 4 to the power grid 50.

The second target output value is determined based on the proportional relationship of the continuous charging time and the continuous discharging time. Here, the continuous charging time means the possible charging time from the state of charge of the battery cell 31 at this point in time while charging at the maximum charging rate, in other words, the time required to maximally charge the battery cell 31 from a certain point in time. The continuous discharging time means the possible discharging time from the state of charge of the battery cell 31 at this point in time while discharging at the maximum discharge rate, in other words, the time required to completely discharge the battery cell 31 from a certain point in time.

After computing the continuous charging time and the continuous discharging time, the controller 5 computes the second target output value based on these. Then the controller 5 controls the charge and discharge of the battery cell 31 such that the sum of the power output of the power generator 2 and the charge and discharge amount of the battery cell 31 is the second target output value, as well as controlling the battery cell 31 such that the state of charge results in a substantially equal continuous charging time and the continuous discharging time. In other words, when the continuous charging time is longer than the continuous discharging time, smoothing is performed so that the performance of charging is controlled so that there is more charging (less discharging) performed. When the continuous discharging time is shorter than the continuous charging time, smoothing is performed so that the performance of charging is controlled so that there is less charging (more discharging) performed. In the first embodiment, because the maximum charge rate and the maximum discharge rate, respectively, are 1It and 4It, smoothing is performed while controlling the chare and discharge so that in the end the state of charge is 0.8 (80%).

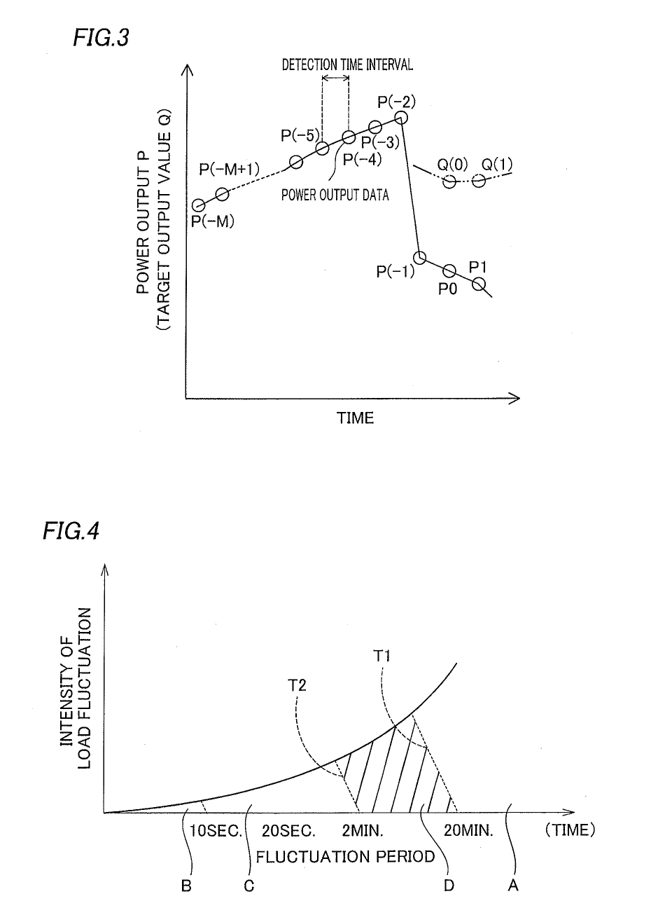

The computation method of the first target output value is explained while referring to FIG. 3. Firstly, the sampling period is set at 20 minutes and the detection time interval is one second, and the number M of previous samples of data in the last 20 minutes was 1200. As shown in FIG. 3, the controller 5 computes the first target output values as the mean value of the newest M number of samples of power output data (current values) included in the last 20 minute sampling period (P (−M), P (−M+1), . . . P (−2), P (−1)). Specifically, the controller 5 sequentially accumulates the power output data (P (−M), P (−M+1), . . . P (−2), P (−1)) in memory 5b. Then, the controller 5 computes the first target output value (Q (0)=(P (−M)+P (−M+1)+ . . . +P (−2)+P (−1))/M) by dividing the sum (P (−M), P (−M+1), . . . P (−2), P (−1)/M) of the latest number of data samples accumulated in memory 5b on the amount of power generated by the number M.

[symbol]

Next, the computation of the second target output value is explained while referring to FIG. 2. In FIG. 2, the first target output value is F, and the second target output value is H, the continuous charging time is Tc and the continuous discharging time is Td. Moreover, the maximum value for the power output to the power grid 50 by the supply section 4 is Imax (The sum of the power output of the power generator 2 and the maximum discharge amount of the battery 3), and the minimum value for the power output to the power grid 50 by the supply section 4 is Imin (The sum of the power output of the power generator 2 and the maximum charge amount of the battery 3). Now, when the current value of the power generated by the power generator 2 is a positive value, the current value of the discharged power from the battery device 3 is a positive value, and the current value of the charge power of the battery 3 is a negative value. In referring to FIG. 2, the second target output value H, when the continuous charging time Tc is less than the continuous discharging time Td, when the continuous charging time Tc is greater than the continuous discharging time Td, and when the continuous charging time Tc is equal the continuous discharging time Td, is computed by use of the following formulae (1), (2) and (3), respectively.

Tc<Td:H=[2TcF±Imax(Td−Tc)]/(Tc+Td) (1)

Tc>Td:H=[2TdF+Imin(Tc−Td)]/(Tc−Td) (2)

Tc=Td:H=F (3)

As shown in FIG. 2, when the continuous charging time Tc is less than the continuous discharging time Td (Formula (1)), when the continuous charging time Tc is greater than the continuous discharging time Td (Formula (2)), as the difference A (A=|Td−Tc|/2) between the continuous charging time Tc and the continuous discharging time Td grows larger, the difference B between the first target output value F and the second target output H grows larger.

Now, according to the graph in FIG. 2, the computation of the second target output value H is performed when the first target output value F is less than the maximum value Imax of the output current value to the power grid 50, and greater than the minimum value Imin of the output current value to the power grid 50. When the first target output value F is greater than the maximum value Imax of the output current value, the controller 5 fixes the second target output value H at Imax so as not to exceed Imax, and when the first target output value F is less than the minimum value Imin of the output current value, the controller 5 fixes the second target output value H at Imin so as not to undershoot Imin.

Furthermore, the controller 5 acquires the power output data and performs the computation of the first target output value and the second target output value on a specific time interval schedule (every one second in the first embodiment), and according to the acquired power output and the computed second target output value, performs charge and discharge for one second until the next computation of the second target output value.

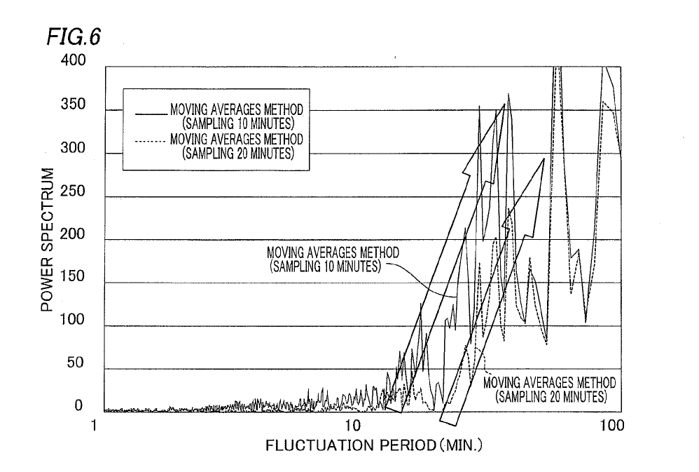

Next, an explanation is provided while referring to FIG. 4 on the fluctuation period range which performs the smoothing by the charge and discharge control of the battery 3 by the controller 5. As shown in FIG. 4, the control methods which can be used are different depending on the fluctuation periods. The domain D (The domain shown shaded) represents a fluctuation period where the load can be dealt with by the load frequency control. Moreover, the domain A shows a fluctuation period where the load can be dealt with by the EDC. Now the domain B is a domain where the effects of the load fluctuation can be naturally absorbed by the endogenous control of the power grid 50. Moreover, the domain C is a domain which can be dealt with by the governor free operation of the generators in each power generating location. Here, the border line between domain D and domain A corresponds to the upper limit period T1 of the fluctuation periods of the loads which can be dealt with by the load frequency control and the border line between domain C and domain D corresponds to the lower limit period T2 of the fluctuation periods of the loads which can be dealt with by the load frequency control. This upper limit period T1 and the lower limit period T2, are not characteristic periods of FIG. 6, and can be understood to be numerical values fluctuating with the intensity of the load fluctuations. The duration of the fluctuation period drawn fluctuates with the configuration of the power network. In this embodiment, looking at the load fluctuation which have the fluctuation periods (fluctuation frequencies) are included in the range of the domain D (a domain which LFC can deal with) but which governor free operation or endogenous control of the power grid 50 and EDC cannot deal with, the objective is enable to suppress the load fluctuation.

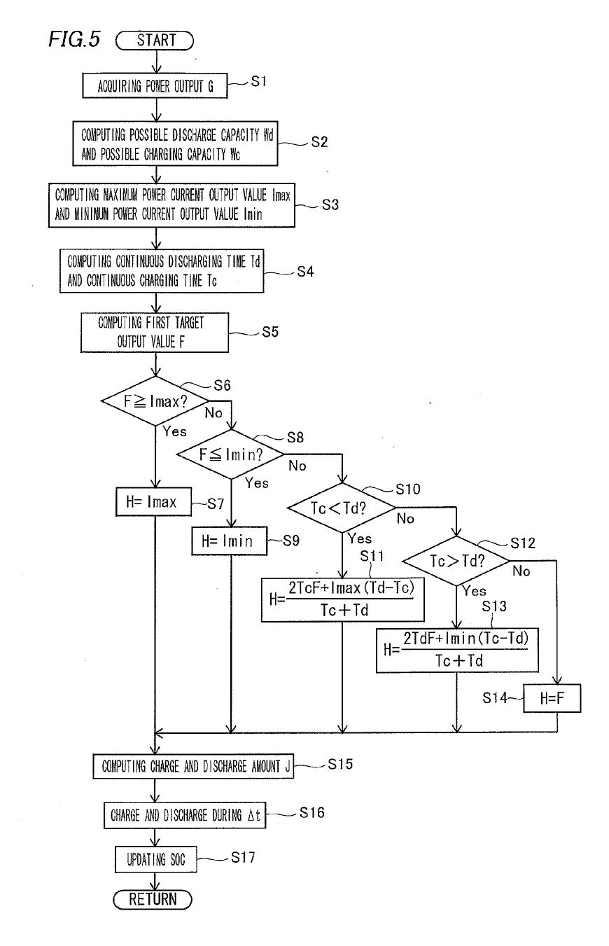

Next, the flow of the charge and discharge control by the controller 5 is explained while referring to FIG. 2 and FIG. 5.

As shown in FIG. 5, in Step S1, the controller 5 acquires the power output (the current flow value) G(t) of the power generator 2 at the time t based on the detected result of the detector 8.

Next in Step S2, the controller 5 computes the possible charging capacity Wc(t) of the charging of the battery 3 and the possible discharge capacity Wd(t) for the discharge of the battery 3 in a specific time interval Δt (between time t to the point in time (t+Δt) (One second in the first embodiment). If the capacity of the battery cell 31 is X (a fixed value), the charge state at time t is SOC (t) (0 is discharge completely, 1 is fully charged), the maximum charge rate is Nc (a fixed value), the maximum discharge rate is Nd (a fixed value) then the possible charging capacity Wc(t) and the possible discharge capacity Wd(t) are computed, respectively, using the following equations (4) and (5).

Wc(t)=Min(Nc×X×Δt,X×(1−SOC(t)) (4)

Wd(t)=Min(Nd×X×Δt,X×SOC(t)) (5)

Here, in equations (4) and (5), the ‘Min ( . . . , . . . )’ means that, of the two values in parenthesis, it is the lesser value. In other words, in order to compute the possible charging capacity Wc(t), basically the computed value based on the maximum charge rate Nc is employed (Nc×X×Δt), but when the battery cell 31 approached full charge (SOC (t)=1), and the computed value for the reserve power for charging (X×(1−SOC(t)) is less than that based on the maximum charge rate Nc (Nc×X×Δt), that reserve power for charging can be used (X×(1−SOC(t)). In the same manner, in order to compute the possible discharge capacity Wd (t), basically the computed value based on the maximum discharge rate N_{d} is employed (Nd×X×Δt), but when the battery cell 31 approached full discharge (SOC (t)=0), and the computed value for the reserve power for discharging (X×SOC(t)) is less than that based on the maximum discharge rate Nd (Nd×X×Δt), that reserve power for discharging can be used (X×SOC(t)).

Then in Step S3, based on the power current value G (t) for the power generator 2 acquired in Step S1, the possible discharge capacity Wd(t) and the possible charge capacity Wc(t), the maximum power current output value Imax and the minimum power current output value Imin which can be output to the power grid 50 from supply section 4 in the time t to time (t+Δt) can be computed. The maximum power current output value Imax and the minimum power current output value Imin are computed, respectively, based on the following equations (6) and (7)

Imax(t)=G(t)+Wd(t)/Δt (6)

Imin(t)=G(t)−Wc(t)/Δt (7)

Moreover, in Step S4, the controller 5 computes the time duration of charging at the maximum charge rate Nc (The continuous charging time Tc (t)), and the time duration of discharging at the maximum discharge rate Nd (The continuous discharging time Td (t)), from the state of charge at time t, based on the state of charge SOC (t) of the battery cell 31 at time t, the maximum charge rate N_{c} and the maximum discharge rate Nd. The continuous charging time Tc (t), and the continuous discharging time Td (t) are computed based on the following formulae (8) and (9).

Tc(t)=X×(1−SOC(t))/Nc (8)

Td(t)=X×SOC(t)/Nd (9)

Next, in Step S5, the controller 5 computes the first target output value F(t), based on the past data using the moving average method. Then, thereafter, in steps S6 to step S14, the controller 5 computes the second target output value H (t) based on the first target output value F(t), the continuous charging time Tc (t), and the continuous discharging time Td (t).

Specifically, firstly in step S6, the controller 5 makes a determination as to whether F(t)≧Imax (t) is satisfied or not. Then, in the situation that F(t)≧Imax (t) is satisfied (The situation where the first target output value F is greater than the maximum power current value Imax to the power grid 50), then in step S7, the second target output value H is fixed at the Imax (t) computed in step S3. Furthermore, in the situation that F(t)≧Imax (t) is not satisfied (The situation where the first target output value F is less than the maximum power current value Imax to the power grid 50), in step S8, a determination is made as to whether F(t)≦Imin (t) is satisfied or not. Then, in the situation that F(t)≦Imin (t) is satisfied (The situation where the first target output value F is less than the minimum power current value Imin to the power grid 50), then in step S9, the second target output value H is fixed at the Imin (t) computed in step S3. By performing the processes of Steps S6˜S9, in respect of the charge and discharge control, the charging is enabled at a charge rate which is not in excess of the maximum charge rate Nc, and in the case of discharging control, the discharging is enabled at a discharge rate which is not in excess of the maximum discharge rate Nd. Moreover, in the situation that F(t)≦Imin (t) is not satisfied (The situation where the first target output value F is greater than the minimum power current value Imin to the power grid 50), then the system progresses to step S10.

In Steps S10˜S14, as shown in FIG. 2, the second target output value H(t) is determined based on which is greater and smaller of the continuous charge time Tc (t) and the continuous discharge time Td (t) computed in step S4. Specifically, in step S10, the charge and discharge controller 5 determines whether Tc (t)<Td (t) is satisfied or not. In the event that Tc (t)<Td (t) is satisfied (The situation that the continuous charge time Tc (t) is less than the continuous discharge time Td (t)), then in step S 11, the second target output value H (t) is determined by formula (1). In the event that Tc (t)<Td (t) is not satisfied, then in step S 12, then the charge and discharge controller 5 determines whether Tc (t)>Td (t) is satisfied or not. In the event that Tc (t)>Td (t) is satisfied (The situation that the continuous charge time Tc (t) is greater than the continuous discharge time Td (t)), then in step S13, the second target output value H (t) is determined by formula (2). In the event that Tc (t)>Td (t) is not satisfied, Tc (t)=Td (t), then in step S14, the second target output value H (t) is set to equal the first target output value F (t). The second target output value H (t) is determined by means of the processes of Steps S6˜S14.

Next, in Step S15, the controller 5 determines the charge and discharge amounts (the current value) J(t) of battery cell 31 by means of the following formula (10) based on the already determined second target output value H (t) (the current value), and the power output G (t) (the current value) of the power generator 2.

J(t)=H(t)−G(t) (10)

Then, in Step S16, the controller 5 controls the charge and discharge means 32 to perform charge and discharge during just Δt for the computed charge and discharge amount J (t) in Step S15. Now when the J (t) is a positive value, it is a discharge, and when it is a negative value it is a charge.

Thereafter, in Step S17, the controller 5 computes the state of charge of the battery cell 31 (SOC (t+Δt)) by the following formula (11).

SOC(t+Δt)=SOC(t)−Δt×J(t)/X (11)

Then, returning to Step S1, the steps S1˜S17 are repeated while the charge and discharge control is performed. By this means, the charge and discharge of the battery 3 is controlled to constrict the state of charge of the battery cell 31 to finally make the continuous charge time Tc and the continuous discharge time Td equal (this is 0.8 (80%) in the first embodiment).

Next, an explanation is provided showing specific values (the current values) of the flow of the charge and discharge control shown in FIG. 5. In one example here, the state of charge, SOC (t), of the battery cell 31 is 0.85 (85%) at the specific time t, an explanation is provided of the situation where the power current G (t) of the power generator 2 at the time t is 100 A, and the first target output value F (t) for the time t computed using the moving average method is 110 A. Now the capacity X of the battery cell 31 is 10 Ah.

In this situation, from formula (4), Wc(t)=Min(1×10×1/3600, 10×(1−0.85)=1/360 Ah, and from formula (5) Wd(t)=Min(4×10×1/3600, 10×0.85=1/90 Ah. Therefore, from formula (6), Imax (t)=100+(1/90)÷(1/3600)=140 A, and Imin (t)=100 1/360÷(1/3600)=90 A.

Moreover, based on formula (8), Tc(t)=10×(1−0.85)÷1=1.5 h, and from formula (9), Td(t)=10×0.85÷4=2.125 h.

In this situation, the value of the first target output value F (t) (110 A) is greater than the Imin (t) of 90 A, and less than the Imax (t) of 140 A. Moreover, from the size relationship of the Td(t)=2.125 h and the Tc(t)=1.5 h, and Td(t)>Tc(t) is satisfied. Therefore the second target output value H (t) can be computed from formula (1) (Step S11) in the following manner. H (t)=(2×1.5×110+140×(2.125−1.5))÷(2.125+1.5)≈115.17 A.

Therefore, according to formula (10), the controller 5 performs a discharge of 115.17−100=15.17 A in the one second from time t.

Thereafter, the state of charge SOC (t+Δt) after the passage of Δt (1 second) is computed based on formula (11). This becomes SOC (t+Δt)=0.85−(1/3600)×15.17÷10≈0.8496. In other words, while the state of charge at time t was 0.85, after the passage of Δt the continuous charting time Tc and the continuous discharging time Td result in approximating a more equalized state of charge (0.8).

The power generation system 1 of this embodiment enables the following benefits based on the configuration and controls described above.

The controller 5 controls the charging and discharging of the battery 3 so as to smooth the power output which is output to the power grid 50 from the supply section 4, based on the relationship of the maximum charging rate to the maximum discharging rate of the battery 3. By this means, the performance of smoothing such that the state of charge of the battery 3 in accordance with the relationship of the maximum charging rate to the maximum discharging rate is enabled, and smoothing can be performed while using the charge and discharge functions of battery 3 effectively.

Furthermore, in smoothing, the controller 5 controls the battery 3 such that the continuous charging time and the continuous discharging time become substantially equal. By the configuration described above, smoothing is enabled while performing charging and discharging such that the reserve power for charging and the reserve power for discharging of the battery 3 are substantially equal. By this means, even when the capacity of the battery 3 is small, because smoothing is enabled while securing both of the reserve power for charging and the reserve power for discharging are secured, a contrivance at capacity reduction of the battery 3 is enabled.

Moreover, the controller 5 computes the first target output value based on the power output data of the power generator 2, as well as computing the second target output value based on first target output value, and the relationship of the maximum charging rate and the maximum discharging rate, and controls the charging and discharging of the battery 3 such that the output from the supply section 4 to the power grid 50 is the second target output value. By means of this configuration, the correction of the first target output value in consideration of on the first target output value and the relationship of the maximum charging rate and the maximum discharging rate, in order to compute the second target output value, is enabled. By controlling the charging and discharging of the battery 3 such that the output from the supply section 4 to the power grid 50 is the second target output value, smoothing is enabled while utilizing the charge and discharge capacity of the battery 3 effectively.

Furthermore, when the continuous charging time is longer than the continuous discharging time, the controller 5 not only controls the performance in the direction of charging such as to lessen the second target output value, rather than the first target output value, but also when the continuous charging time is shorter than the continuous discharging time, the controller 5 not only controls the performance in the direction of discharging such as to enhance the second target output value, rather than the first target output value. By means of this configuration, when the continuous charging time is longer than the continuous discharging time (The reserve power for charging is greater than the reserve power for discharging), because smoothing is enabled while ensuring that the charged amount of the battery 3 is increased (or that the discharge amount is reduced), the state of charge of battery 3 can be approximated to a state of charge where the continuous charging time and the continuous discharging time are substantially equal while performing smoothing. In the same manner, when the continuous charging time is shorter than the continuous discharging time (The reserve power for discharging is greater than the reserve power for charging), because smoothing is enabled while ensuring that the charged amount of the battery 3 is decreased (or that the discharge amount is increased), the state of charge of battery 3 can be approximated to a state of charge where the continuous charging time and the continuous discharging time are substantially equal while performing smoothing.

Furthermore, the controller 5 computes the continuous charging time enabling the continuance of charging at the maximum charging rate, and the continuous discharging time enabling the continuance of discharging at the maximum discharging rate, based on a state of charge, the maximum charging rate and the maximum discharging rate of the battery 3, and maximizes the difference between the first target output value and the second target output value in accordance with the difference between the continuous charging time and the continuous discharging time. By means of said configuration, when the difference between the continuous charging time and the continuous discharging time is great, smoothing is enabled while performing charging and discharging such as to approximate the state of charge where the continuous charging time and the continuous discharging time are equal.

Moreover, when the first target output value is greater than the sum (Imax) of the maximum discharge current amount based on the maximum discharge rate, and the power output of the power generator 2, the controller 5 not only controls the second target output value to match the Imax. When the first target output value is less than the sum (Imin) of the maximum charge current amount based on the maximum charge rate, and the power output of the power generator 2, the controller 5 controls the second target output value to match the Imin. By means of the configuration described above, on the occasion of the performance of smoothing, because charging at a charge rate greater than the maximum charge rate, and discharging at a discharge rate greater than the maximum discharge rate are not performed, the overloading of the battery 3 can be suppressed. By this means, a contrivance at lengthening the lifetime of the battery 3 is enabled.

Furthermore, by the acquisition of the power output data of the power generator 2, and the detection or the computation of the state of charge of the battery 3, at specific time intervals, the controller 5 not only computes the first target output value and the second target output value at specific time intervals. The controller 5 outputs power of the second target output value to the power grid 50 from supply section 4. By means of the configuration described above, smoothing is enabled while performing charging and discharging in correspondence with the state of charge at that time intervals.

Moreover, when a battery 3 is utilized where the maximum charge rate and the maximum discharge rate are mutually distinct, by controlling the charging and discharging of the battery 3 in order to perform smoothing based on the relationship of the maximum charge rate and the maximum discharge rate, the controller 5 enables the performance of smoothing while effectively utilizing the charge and discharge capacities of the battery 3.

Next, the sampling periods of the moving average method in order to compute the first target output value in the first embodiment are investigated. Here, the results of the FFT analysis of the output power to the power grid when the sampling period which is the acquisition period of the power output data was 10 minutes, and the results of the FFT analysis of the output power to the power grid when the sampling period was 20 minutes are shown in FIG. 6. As shown in FIG. 6, it can be appreciated that when the sampling period was 10 minutes, while the fluctuations in respect of a range of up to 10 minutes of a fluctuation period could be suppressed, the fluctuations in a range of fluctuation periods which were greater than 10 minutes were not suppressed well. Moreover, when the sampling period was 20 minutes, while the fluctuations in respect of a range of up to 20 minutes of a fluctuation period could be suppressed, the fluctuations in a range of fluctuation periods which were greater than 10 minutes was not suppressed well. Therefore, it can be understood that there is a good mutual relationship between the size of the sampling period, and the fluctuation period which can be suppressed by the charge and discharge control. For this reason, it can be said that by setting the sampling period, the range of the fluctuation period which can be controlled effectively changes. In that respect, in order to suppress parts of the fluctuation period which can be addressed by the load frequency control which is the main focus of this system, it can be appreciated that it is preferable that sampling periods which are greater than the fluctuation period corresponding to the load frequency control should be set, in particular, from the vicinity of the latter half of T1˜T2 (The vicinity of longer periods) to periods with a range greater than T1. For example, in the example in FIG. 6, by utilizing a sampling period of greater than 20 minutes, it can be appreciated that suppression of most of the fluctuation periods corresponding to the load frequency control is enabled. However, when the sampling period is lengthened, there is a tendency for the required battery cell capacity to become greater, and it is preferable to select a sampling period which is not much longer than T1.

### Embodiment 2

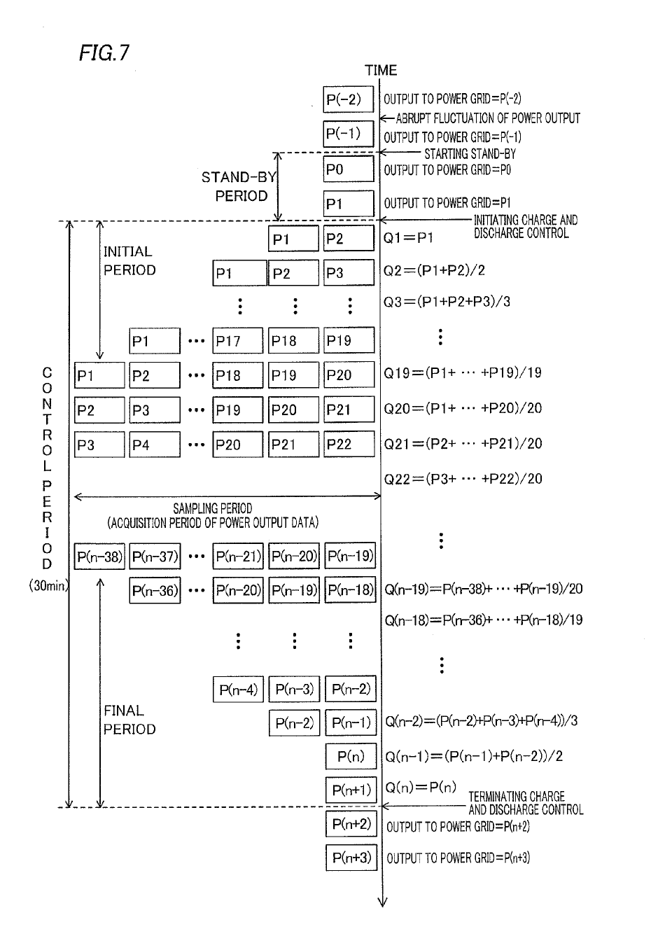

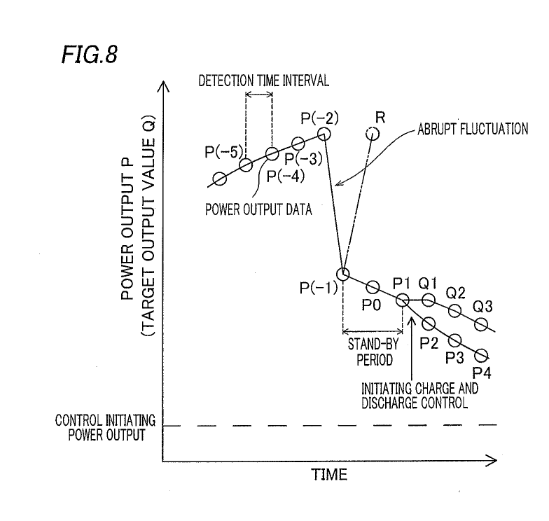

Next, the power generation system of embodiment 2 of the present invention is explained while referring to FIG. 7 and FIG. 8.

In cloud free fine weather, because there is almost no fluctuation in the incident sunlight due to clouds, the fluctuation amount in the power output of power generator 2 is very small. Moreover, in rainy weather, while there is fluctuation in the amount of incident sunlight, because the actual amount of incident sunlight itself is very small, the power output of power generator 2 and the fluctuation amount in the power output are very small. For these reasons, even if the charge and discharge control of the battery cell 31 is not performed by the controller 5, the effects imparted to the power grid 50 are minute.

In embodiment 2, unlike the performance of normal charge and discharge control in the first embodiment, an example of the performance of charge and discharge control of the battery 3 in situations, limited to those other than fine weather and rainy weather, is explained. Now the configuration of the power generation system in embodiment 2 is the same as in embodiment 1, other than contents of the control of the controller 5.

In embodiment 2, the controller 5 does not perform charge and discharge control all the time, charge and discharge control is only performed when specific conditions are met. Specifically, the controller 5, in situations when the output of the power generation of the power generator 2 as is to the power grid 50 would have adverse effects on the power grid 50. In other words, charge and discharge control is only performed when the power output of the power generator 2 is greater than a specific amount (Hereafter referred to as ‘control initiating power output’), in addition to when the fluctuation amount in the power output of the power generator 2 is greater than a specific fluctuation amount (Hereafter referred to as ‘control initiating fluctuation amount). The control initiating power output, for example, is a power output which is greater than the power output in rainy weather, and can be set to 10% of the rated power output of the power generator 2. Moreover, the control initiating fluctuation amount, for example, is the fluctuation amount which is greater than the maximum fluctuation amount between each detection time interval in the midday time band of fine weather (blue skies with almost no cloud), and can be set to be 5% of the pre-fluctuation power output. Moreover, the fluctuation amount in the power output can be acquired by computing the difference between two sequential power output data of the power output of the power generator 2 as detected at specific detection time intervals. Now, when the detection time intervals are modified, the specific numerical values cited above need to be reset and the control initiating power output and the control initiating fluctuation amount need to be set in accordance with the detection time intervals.

When the power output of the power generator 2 transitions from a state where the power output is less than the control initiating power output to a state where the power output is greater than the control initiating power output, the controller 5 initiates the detection of the fluctuation amount of the power output of the power generator 2. Then, when the fluctuation amount in the power output of the power generator 2 is greater than the control initiating fluctuation amount, the charge and discharge control is initiated for the first time. Even when the power output of the power generator 2 is a power output which is greater than the control initiating power output, but the fluctuation amount in the power output of the power generator 2 is not greater than the control initiating fluctuation amount, charge and discharge control is not performed. Furthermore, when the power output of the power generator 2 is a power output not in excess of the control initiating power output, and the fluctuation amount in the power output of the power generator 2 becomes less than the control initiating fluctuation amount, the detection of the fluctuation amount of the power output of the power generator 2 is terminated.

Moreover, even when the fluctuation amount in the power output of the power generator 2 is greater than the control initiating fluctuation amount, when the controller 5 detects a return of the power output to the vicinity of the pre-fluctuation power output within a stand-by period from the point in time when the fluctuation greater than the control initiating fluctuation amount was detected, because the adverse effects imparted to the power grid 50 are few, the charge and discharge control are not initiated.

The stand-by period described above is a period which is less than a fluctuation period which the load frequency control (LFC) can deal with, and preferably, is a period which is less than the upper limit period T1 shown in FIG. 4, and even more preferably is less than the lower limit period T2.

Moreover, the stand-by period is greater than the detection time interval, and is more than twice the detection time interval (for example, an integral amount which is equal to or greater than two times the detection time interval). Furthermore, a value which is in the vicinity of the pre-fluctuation power output specifically means a value between a upper threshold value which is a small amount greater than the pre-fluctuation power output (e.g. 101%), and a lower threshold value which is a small amount less than the pre-fluctuation power output (e.g. 99%).

The point described above is explained while referring to FIG. 8. In the event that the power output is abruptly reduced from power output P (−2) to power output P (−1), and in the event that the value does not return to the power output P (−2) value from the point when the power output P (−1) is detected within the stand-by period (does not increase), the charge and discharge control is initiated. In the example shown in FIG. 8, the stand-by time is set at one minute and because the detection of power output P0 and power output P1 detected within the stand-by time after the detection of power output P (−1) are not values in the vicinity of the power output P (−2), the charge and discharge control was initiated at the point that power output P1 was detected. In the event that a value R (a value R which is greater than 99% of the lower threshold value of power output P (−2)) in the vicinity of the power output P (−2) is detected within the stand-by time after the power output P (−1), a determination is reached that there is a return to the value to the vicinity of the power output P (−2) before the fluctuation, and the charge and discharge control is not initiated.

Moreover, after the initiation of the charge and discharge control, and after a specific control period has elapsed, the controller 5 terminates the charge and discharge control. The control period is at least greater than the sampling period determined based on the fluctuation period range in correspondence to the load frequency control. In the event that a procedure is adopted to shorten the data acquisition period of the power output data in either the initial or final period of the charge and discharge control, the control period has as a minimum period of the sampling period with the shortened data acquisition period added thereto. When the control period is too short, the control effectiveness in the fluctuation period range, corresponding to the load frequency control, becomes weak, whereas when the control period is too long, the frequency of the number of instances of charge and discharge increases, resulting in the reduction in the lifetime of the battery cell and there is a need to set the control period to an appropriate duration.

Furthermore, even during smoothing, when the fluctuation amount of the power output reaches a value above a specific value (the control reinitiating fluctuation amount), the sampling for the purposes of the moving average is returned to the beginning, and the processes of the moving average are initiated anew from that time point. The control restart fluctuation amount is a value which is greater than the control initiating fluctuation amount.

Moreover, in the control period, in the event that the power output of the power generator 2 is less than the control initiating power output, even if the control period has not yet elapsed, the controller 5 terminates the charge and discharge control.

Next, an explanation is provided of the computation method of the first target output value by the controller 5 of the power generation system of embodiment 2, while referring to FIG. 7 and FIG. 8. In the second embodiment the control period is set at 30 minutes.

Firstly it is posited that the fluctuation amount in the power generation is as shown in FIG. 8. Now, FIG. 8 shows an example where the power output fluctuate abruptly downwards, even if the power output rise abruptly, the computation method of the first target output value is the same as explained below.

In the event that there is an abrupt fluctuation in the power output as shown in FIG. 7, in respect of the periods other than the initial period and the final period of the charge and discharge control, the controller 5 computes the first target output value from the mean value of 20 power output data samples included in the past 10 minute long sampling period. On the extremes thereof, in the initial period of the charge and discharge control (the 10 minutes from when the charge and discharge control was initiated) and in the final period (the 10 minutes until the termination of the charge and discharge control is planned), the controller 5 is configured to compute the first target output value from the power output data in periods shorter than the power output data sampling period (10 minutes, 20 power output data samples) in the periods other than the initial and final charge and discharge control periods.

Specifically, in the initial period of the charge and discharge control, the controller 5 not only sequentially accumulates the power output data (P1, P2 . . . ) from the start of the charge and discharge control onwards in memory 5b, but also gradually increases the sampling period for the power output data from the start of the charge and discharge control, in correspondence with the accumulated data amount.

In other words, as shown in FIG. 7, to explain the situation whereby between the gpower output P (−2) detected at a certain timing of the detection of the power output, and the next power output P (−1) at the next timing of the detection of the power output, there is a big fluctuation generated, moreover, if there is the recognition that the power output does not return to the vicinity of the power output P (−2) within the stand-by period such that the charge and discharge control is initiated, in that situation, the first target output value Q1, after the initiation of the charge and discharge control, is that same power output data P1 acquired immediately before, and the second sample in the first target output value Q2 is the mean of the two power output data accumulated in memory 5b (the power output data P1 and P2 acquired immediately prior). The third sample in the first target output value Q3 is the mean of the three power output data accumulated in memory 5b (the power output data P1, P2 and P3 acquired immediately prior).

In the same manner, the 20^{th} sample of the first target output value Q20 is the mean of the 20 power output data samples (P1˜P20) acquired most recently and accumulated in memory 5b. At the point where the accumulated amount of the power output data sample reaches 20, there is transition from the initial period, excluding the initial period and the final period. Then, after the number of accumulated data reaches 20 (excluding the initial and final periods) the first target output value is computed based on 20 power output data samples.

When the termination point of the charge and discharge control approaches (Planned termination point), the sampling period for the power output data is gradually reduced in accordance with the planned acquisition amount of the power output data to the end point of the charge and discharge control. Because the planned termination time point of the charge and discharge control is 30 minutes from the start (or extended start), the starting point for the reduction in the sampling period for the power output data can be computed. In other words, at the point when the charge and discharge control reaches 10 minutes before the planned termination point, as well as moving from the periods, other than the initial period and the final period, the sampling period for the power output starts to be reduced from the initiation point of the final period.

Specifically, near the end point of the charge and discharge control (Planned termination point), on computation of the first target output value for the n^{th} time since the start of the control, the first target output value Q (n−19), of the 20^{th} time before the end of the control, is computed from the mean of the immediately prior 20 power output data samples P (n−38)˜P (n−19). The first target output value Q (n−18), of the 19^{th} time before the end of the control, is computed from the mean of the immediately prior 19 power output data samples P (n−36)˜P (n−18). In the same manner, the first target output value Q (n−2), of the third time before the end of the control, is computed from the mean of the immediately prior three power output data samples P (n−4), P (n−3) and P (n−2). The first target output value Q (n−1), of the second last time before the end of the control, is computed from the mean of the immediately prior two power output data samples P (n−2) and P (n−1). Then, the first target output value Q (n), of the last time before the end of the control, is the immediately prior gpower output data sample P (n) itself.

Now, in the event that there has been a fluctuation of the power output of more than a specific amount on a specific number of occasions (3 times in the second embodiment) in the control period, the controller 5 extends the control period. This extension, on the occasion of the detection of the third fluctuation of the power output, is performed by the setting anew of a 30 minute control period. In the event that the control period is extended, and in the event that there is not another detection of three instances of the fluctuation of the power output which is greater than the control initiating fluctuation amount from the third detection point (the initiation point of the extension), the charge and discharge control is terminated 30 minutes after the detection of the third detection point (the initiation point of the extension). In the event that after the detection of the third detection point (the initiation point of the extension), there is the detection of another three instances of the fluctuation of the power output which is greater than the control initiation fluctuation amount, there is yet another 30 minute extension.

The power generation system of this embodiment, enables the derivation of the following benefits by the controls described above.

In the second embodiment, in the event that the power output of the power generator 2 is greater than the control initiating power output, in addition to the fluctuation amount of the power output of power generator 2 being greater than the control initiating fluctuation amount, the charge and discharge control of the battery 3 is performed. By this means, when the power output of the power generator 2 is less than the control initiating power output, or even when the power output of the power generator 2 is greater than the control initiating power output, if the fluctuation amount of the power output from the power generator 2 is less than the control initiating fluctuation amount, charge and discharge control is not performed. As a result, a contrivance at lengthening the lifetime of the battery 3 is enabled by lessening the number of times the battery 3 is charged and discharged. Moreover, the suppression of the adverse effects on the power grid 50 caused by the fluctuations in the power generated by the power generator 2 is enabled.

Furthermore, in the initial periods of charge and discharge control, the controller 5 shortens the sampling period for power output data than the period other than the initial and final periods of the charge and discharge control, to compute the first target output value. By enabling this type of configuration, the use of the power output on the initiation of the charge and discharge control, and the value of the power output when a very different abrupt fluctuation (before charge and discharge control are initiated) occurs, in the computation of the first target power output in the initial period of the charge and discharge control, because the sampling period is set shorter, the use of a power output value before an abrupt fluctuation (Before the initiation of charge and discharge control) with a completely different power output to that at the time of the initiation of the charge and discharge control can be suppressed. By this means, because the difference between the computed first target power output and the actual power output on the initiation of the charge and discharge control can be made smaller, so that not only can the fluctuation in the power output value to the power grid at and about the time of starting the charge and discharge control be reduced, the amount of charge and discharge of the battery 3 to fill in that difference can be reduced. As a result, because the fluctuations in the power which is output to the power grid by the supply section 4 can be suppressed, not only can the adverse effects on the power grid 50 be suppressed, the reduction in the capacity of the battery 3 is enabled.

Moreover, the controller 5 terminates the charge and discharge control after a specific time period has elapsed from the initiation thereof. By means of the configuration described above, by performing charge and discharge control for a fixed time period, compared with not terminating the charge and discharge control, the number of instances of charge and discharge can be reduced, to contrive to enable a longer lifetime of the battery 3.

The other benefits of the second embodiment are the same as those of embodiment 1.

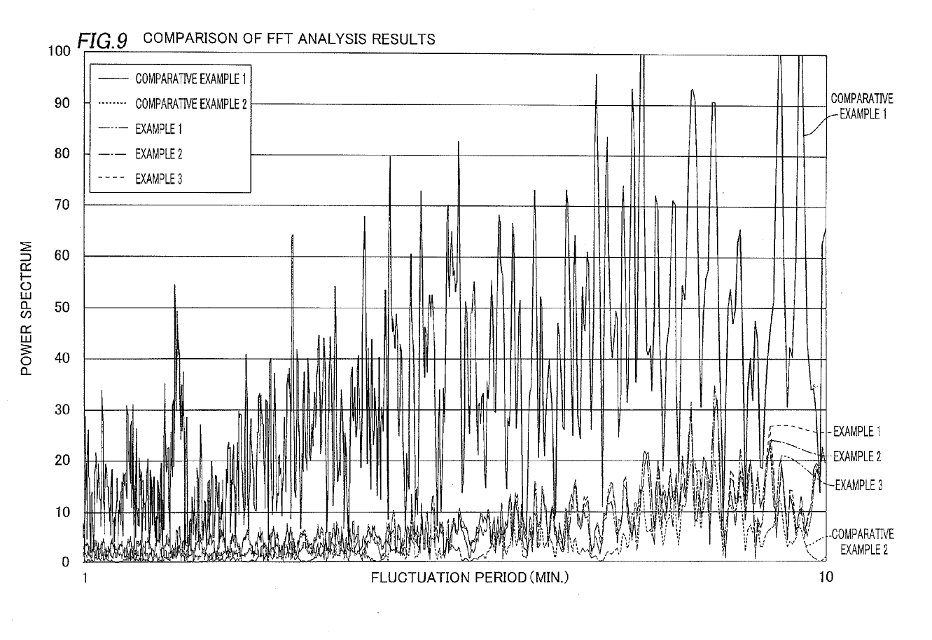

Next, an explanation is provided on an investigation into the alleviation of the adverse effects which the performance of charge and discharge control have on the power grid 50. In FIG. 9 the results of FFT analysis on comparative examples 1 and 2, and examples 1, 2 and 3 are shown. Comparative example 1 is an example where charge and discharge control were not performed (Where the power output of power generator 2 was output, as is, to the power grid). Comparative example 2 is an example where charge and discharge control by a different general moving average method to the one employed in embodiment 1 was performed at all times all day. Now, the general moving averages method is different from that of embodiment 2, wherein the number of samplings (sampling period) in the initial and final periods of the charge and discharge control were reduced, such that the method of the target output value is computed based on the same standard number of samplings, even in the initial and final periods the charge and discharge control. Furthermore, the examples 1˜3, just as in embodiment 2, the monitoring of the power output is initiated when the power output of the power generator 2 exceeds 10% of the rated power output, and charge and discharge control is initiated when the fluctuation of the power output exceeds 5% of the pre-fluctuation power output, and the power output does not return to the vicinity of the pre-fluctuation power output within the stand-by time. Moreover, in examples 1˜3, just as in embodiment 1, charge and discharge control is performed reducing the number of samplings in the initial and final periods of the charge and discharge control. Examples 1, 2 and 3, in the determination of whether the power output returned to the vicinity of the pre-fluctuation power output within the stand-by period, the stand-by period was set at 0, 1 and 2 minutes, respectively.

As shown in FIG. 9, the power spectra of the FFT analysis result of comparative example 2 and examples 1˜3 are reduced compared to comparative example 1. In other words, in comparative example 2 and examples 1˜3, in a comparison with when charge and discharge control was not performed (comparative example 1), the power spectra was greatly reduced. Moreover, in examples 1˜3, in comparison to when a general moving average method was used throughout the day (comparative example 2), because the same level of power output smoothing was enabled, it can be appreciated that the same degree of suppression of the adverse effects on the power grid 50 was enabled as was the case with the all-times, all-day general moving averages method. It can be concluded from the above that if charge and discharge control are performed using that of embodiment 2, it is clear that the same degree of alleviation of adverse effects on the power grid 50 is enabled as when charge and discharge control is performed at all hours, all day using the general moving averages method.

Here, a simple estimate of the results on the lifetime of battery cell 31 in comparative example 2 and examples 1˜3 is represented in Table 1 below. In this case, the total number of charge amount and discharge amount in each of comparative example 2 and examples 1˜3, based on approximately two months worth of power output data, is derived and the inverse thereof was used to estimate a value for the lifetime of the battery cells. Moreover the values for examples 1˜3 was standardized at the value for comparative example 2.

TABLE 1

| | Comparative | | | |
|---|---|---|---|---|
| | example 2 | Example 1 | Example 2 | Example 3 |
| The | 1 | 1.14 | 1.16 | 1.19 |
| estimated | | | | |
| value for the | | | | |
| battery | | | | |
| lifetime | | | | |

As shown in Table 1, with examples 1˜3, a lifetime extension of the battery lifetime of greater than 10% can be expected, compared to comparative example 2. Moreover, the estimated value for the lifetime was increased in examples 2 and 3, compared to example 1. This was because the period of the performance of charge and discharge control was shorter, as a result of the provision of a standby time of one minute and two minutes, respectively, and it is considered that this is the result of the number of times charge and discharge was performed on battery cell 31 being reduced.

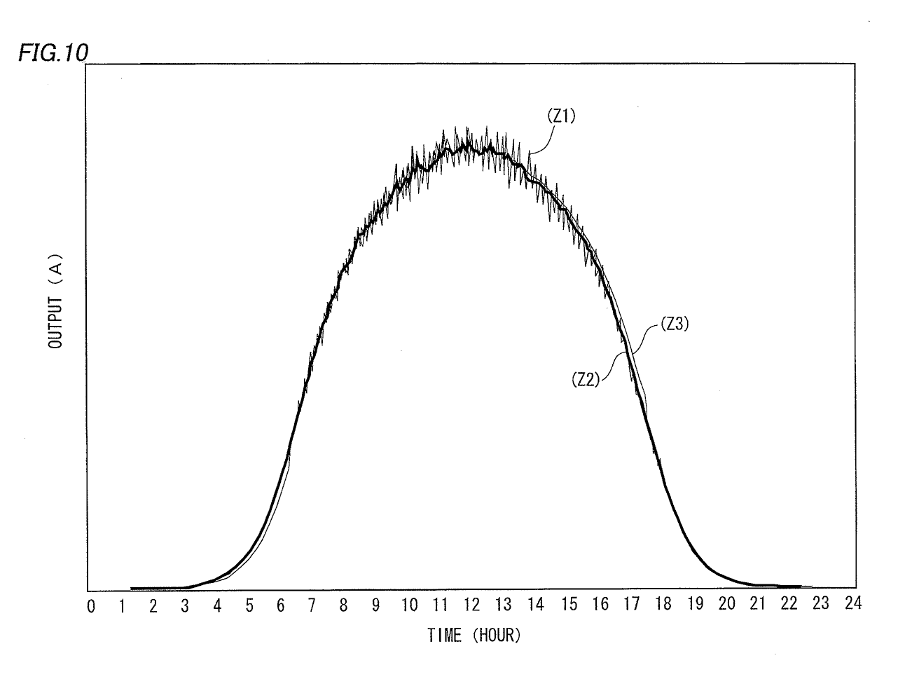

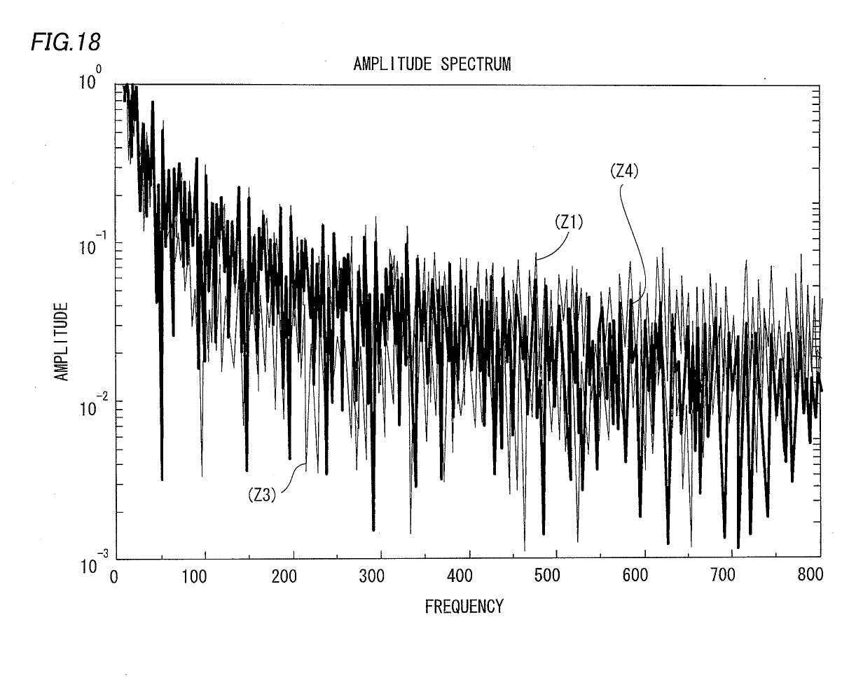

Next, the simulation results proving the effects of embodiments 1 and 2 of the present invention are explained while referring to FIG. 10˜FIG. 18.

In FIG. 10, the simulation results are shown for the time fluctuation trend (Z1) of the generation current of the power generated by the power generator, and the time fluctuation trend (Z2) of the output current when smoothing is performed to the generation current by the control of the first embodiment, and the time fluctuation trend (Z3) of the output current when smoothing is performed to the generation current by the moving average method on its own. While there are frequent power fluctuations generated in Z1, the graph is smoothed in Z2 and Z3, and it can be appreciated that this is because the fluctuation in the output of the power output in Z1 are being smoothed. Moreover, in Z3, it is clear that the smoothing is not performed sufficiently during the morning period.

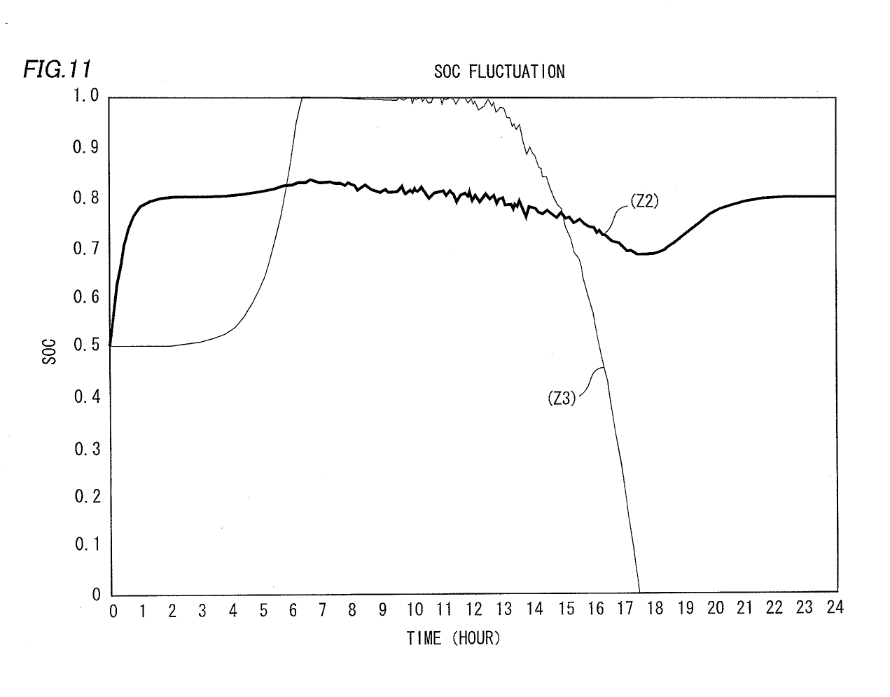

Next, in FIG. 11, the time fluctuation trends for the state of charge (SOC, The initial value of the SOC (0)=0.5) corresponding to Z2 and Z3 in FIG. 10, respectively, are shown. In Z3, the fully charged state (SOC=1) was reached between about 06:00 and 12:00 hours, and in the period from 06:00 to 12:00 hours, the controller 5 was in a state that smoothing by charging thereof was impossible. As the cause of this full charged state, it is considered that the results show that smoothing was not performed sufficiently in Z3 of FIG. 10. On the other hand, in Z2, because smoothing was performed while controlling the charge and discharging so as to achieve an SOC of 0.8, the SOC was maintained while never reaching a fully charged state or a zero power storage state. Moreover, the fluctuation width of the SOC, excepting immediately after the time of starting, was maintained more or less in the 0.7˜0.8 small band. In other words, in Z2, it can be appreciated that even when the capacity of the battery cell is small, the probability of the SOC becoming 0 (0%) or 1 (100%) is small.

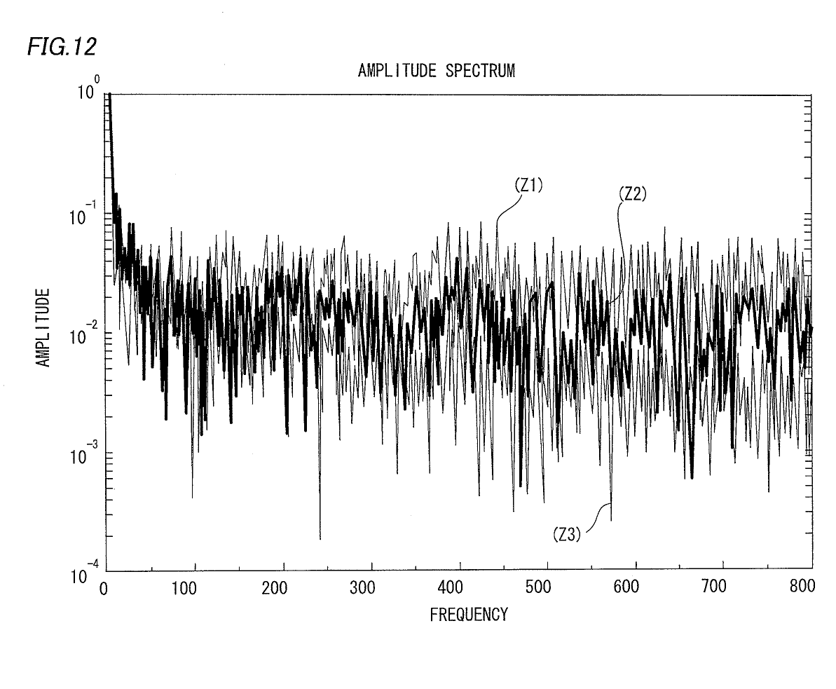

Furthermore, in FIG. 12 the relationship between the frequency and amplitude correspond with each of Z1, Z2 and Z3 in FIG. 10 is represented. Now, the frequency of 720 corresponds to the fluctuation period of two minutes, and the frequency of 72 corresponds to the fluctuation period of 20 minutes. Excepting some long frequencies, overall the amplitude in Z2 and Z3 is smaller than in Z1. In other words, it can be appreciated that smoothing of the fluctuations in output was enabled over a wide range in Z2 and Z3, with the exception of some long period components.

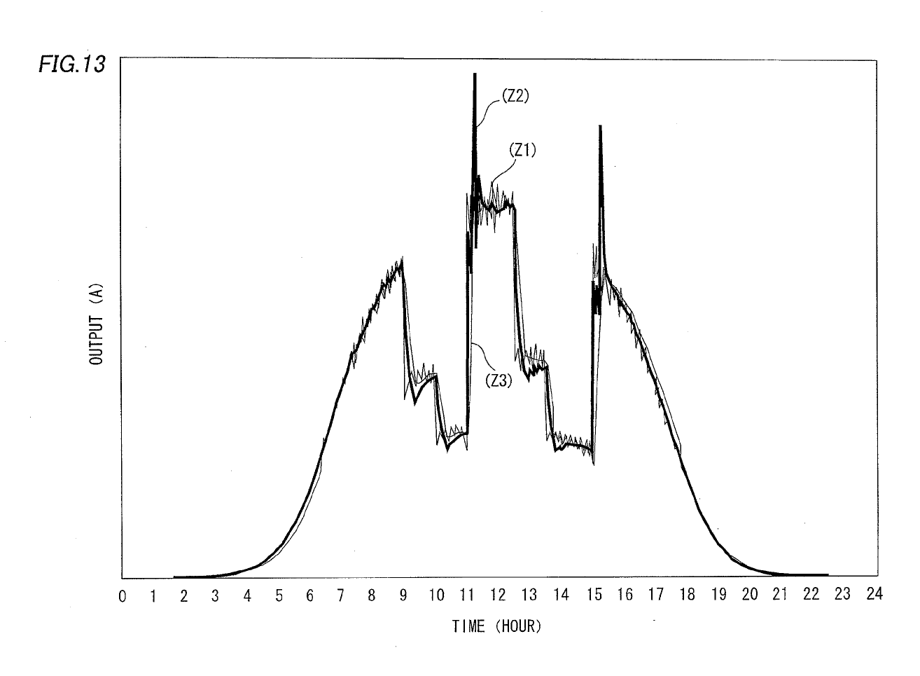

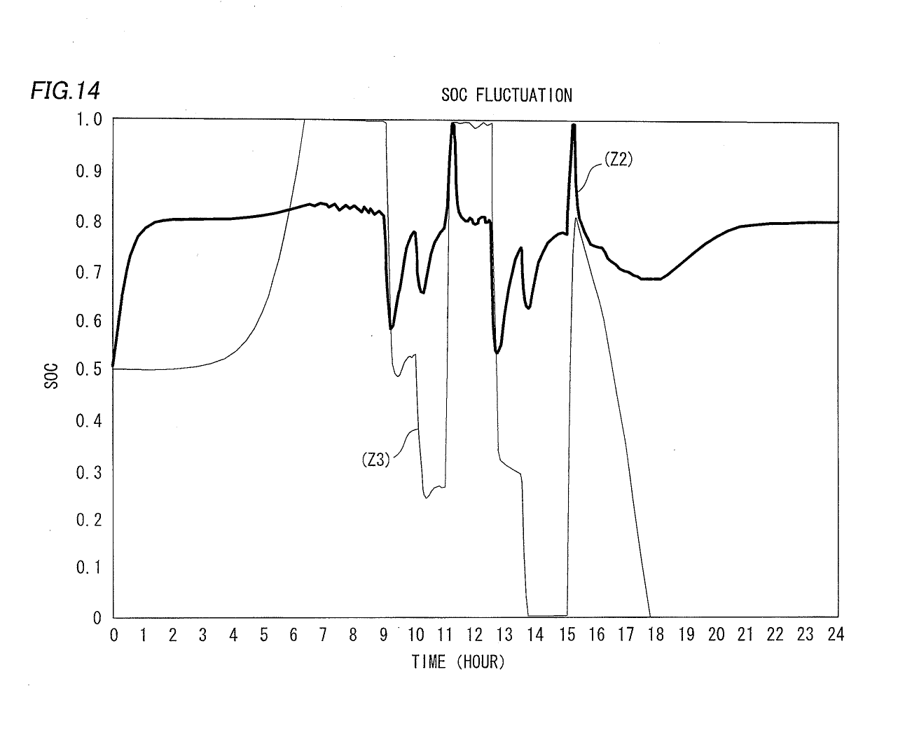

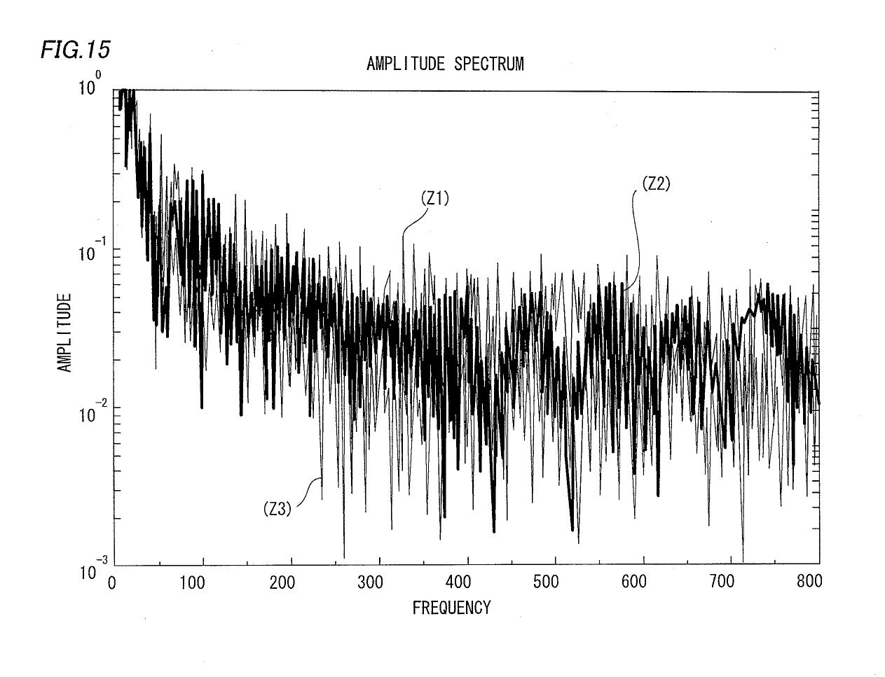

Next, in FIG. 13˜FIG. 15, the results of a simulation performed in the same way as in FIG. 10˜FIG. 12, in respect of output fluctuations of the power generators positing the representation of the change-over in weather between fine weather and cloudy weather. As shown in FIG. 13, it can be appreciated that there is a big fluctuation in the time fluctuation trend (Z1) of the current generated by the power generator. Concomitant with this big fluctuation, as shown in FIG. 14, it can be seen that there is a big fluctuation in SOC in Z2 and Z3. Here, the width of the fluctuations in the SOC is large because there is no limit provided on the charging rate and the discharging rate in Z3. On the other hand, in Z2 because there is a limitation on the charging at greater than the maximum charging rate, and on discharging at greater than the maximum discharging rate, it can be appreciated that the width of the fluctuations is small. Therefore, in a comparison of Z2 with Z3, it can be appreciated that the loading of the battery was less while smoothing was performed. Now as shown in FIG. 15, even when there are large fluctuations in the time fluctuation trends of the output of the power generator as shown in FIG. 13, with the exception of some long wave periods, overall the amplitude of the fluctuations in Z2 and Z3 are smaller than in Z1, and it can be appreciated that smoothing of the fluctuations in output was enabled over a wide range in Z2 and Z3, with the exception of some long period components.

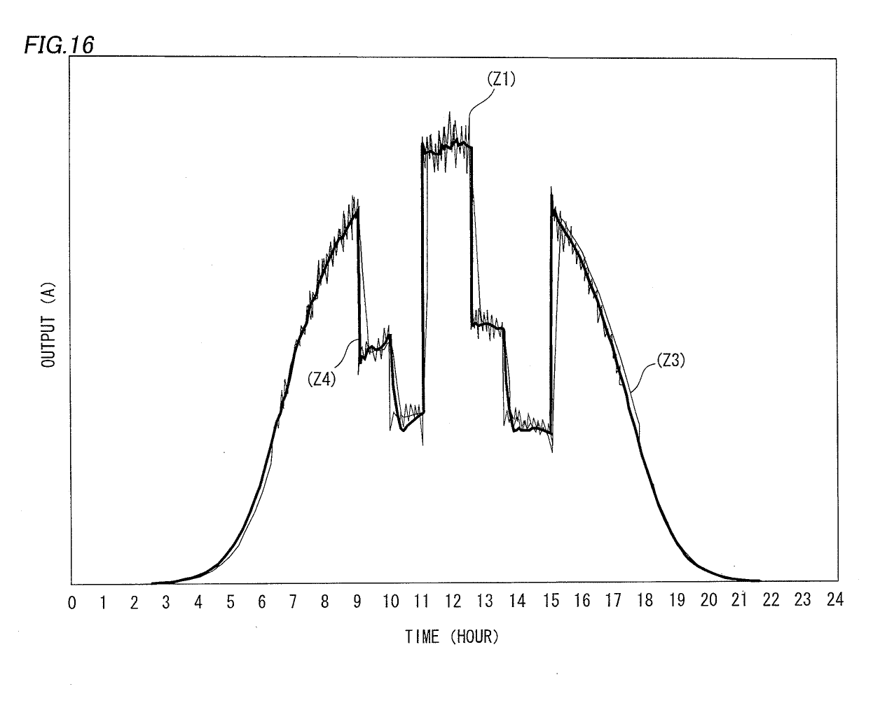

Next, in FIG. 16˜FIG. 18, the results of a simulation performed in the same time fluctuation trend as in Z1 of FIG. 13, and when smoothing was performed by the charge and discharge control of the second embodiment. The Z3 in FIG. 16 is the same as the Z3 in FIG. 13. This is a simulation of the results (Z4) of the performance of smoothing by the charge and discharge control of the second embodiment. Now in this simulation, just as with Z2 and Z3, the detection time interval of the power output is one second, and the sampling period is set at 20 minutes, and as well as setting the control reinitiating fluctuation amount at the value (X×(Nd+Nc)/2) regulated by the capacity X of the battery cell 31, the maximum charging rate Nc, and the maximum discharge rate Nd, the control initiating fluctuation amount is also set at (X×(Nd+Nc)/2)/100.

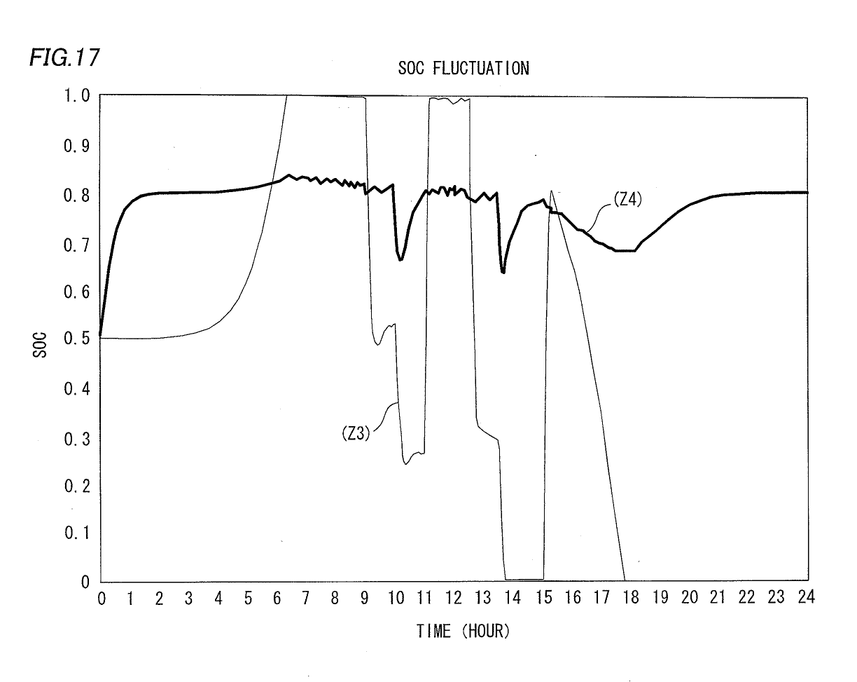

As shown in FIG. 16, it can be appreciated that the smoothing was performed sufficiently in Z4. Furthermore, it can also be appreciated that the peak appearing in the Z2 of FIG. 13 has disappeared in Z4. This because in the charge and discharge control of the second embodiment (Z4), when a large fluctuation occurs in the power output, because the power output data for the period before that fluctuation is not used as the moving average data, but the target output value is computed using the power output data after the fluctuation, immediately after a big fluctuation, the difference between the actual power output value, the first target output value and the second target output value is small, and as a result, it is considered that this is the reason why the amount of charging and discharging to the battery is small. Moreover, as shown in FIG. 17, it can be appreciated that the abrupt fluctuation in the SOC represented in the Z2 of FIG. 14 is reduced in Z4. In particular, the abrupt rise and fall in the SOC at approximately 11:00 hours and 15:00 hours, respectively in FIG. 14, have disappeared in FIG. 17. Now, as shown in FIG. 18, even when charge and discharge control is performed using the second embodiment, just as in FIG. 15, excepting some long period waves, overall the amplitude of Z4 and Z3 are less than Z1, and it can be appreciated that in Z4 and Z3, smoothing was enabled in respect of a wide range of output fluctuations, with the exception of the some long period wave components.

Now, it must be understood that in the embodiments and examples disclosed here, all of the points are for illustrative purposes and are not limiting items. The scope of this patent is represented by the claims and not by the embodiments and examples described above, in addition to including all modifications which have an equivalent meaning to that of the claims and everything falling in that scope.

For example, an explanation was provided of embodiments where the voltage of the battery cell 31 was 48V, but this invention is not limited to this, and voltages other than 48 V may be employed. Now the voltage of the battery cell is preferably below 60V.

Furthermore, an explanation was provided whereby the power consumption in the consumer home was not taken into consideration in the load in the consumer home, but this invention is not limited to this, and in the computation of the first target output value, a power amount is detected wherein at least part of the load is consumed at the consumer location, and the computation of the first target output value is performed considering that load consumed power output or the fluctuation amount in the load consumed power output.

Moreover, an explanation was provided of batteries where the maximum discharge rate was greater than the maximum charge rate, but this invention is not limited to this, and batteries may be employed where the maximum discharge rate is less than the maximum charge rate, or where the maximum discharge rate and the maximum charge rate are equal.

Furthermore, an explanation of an example was provided where the difference between the first target output value and the second target output value corresponded to the differences between the continuous charging time and the continuous discharging time was made greater, but this invention is not limited to this, and the differences between first target output value and the second target output value may be constant.

Moreover, an explanation of an example was provided of the charge and discharge control of the first target output value and the second target output value where the values were computed based on the values of the current, but this invention is not limited to this, and the computation may be based on the power.

Furthermore, in the second embodiment, examples were disclosed wherein both of the sampling periods in the starting time (initial period) and at the time of the termination (final period) of the charge and discharge control were made shorter, but this invention is not limited to these, and the sampling periods in only one of the starting time (initial period) and at the time of the termination (final period) of the charge and discharge control may be made shorter.

Furthermore, in embodiment 2 the control initiating power output was set at 10% of the rate power output of the power generator 2, but this invention is not limited to this, and for example, may be based on the rated output of the power generator. However, the size of the control initiating power output is preferably greater than the control initiating fluctuation amount.

Moreover, in embodiments 2 described above, an explanation was provided whereby the stand-by time was less than 2 minutes, but this invention is not limited to these, and may be greater than two minutes. Now the stand-by time is preferably less than the upper limit period T1 of the fluctuation period of the loads which the load frequency control (LFC) can deal with, even more preferably less than the lower limit period T2. However, the value of the lower limit period may be affected by the so-called running-in/breaking-in effect on the power grid side. Moreover, the size of the running in effect will vary with the degree of the installation [i.e. units installed] of the power generation system and their regional distribution.

Furthermore, in embodiments 2 described above, the upper threshold value and the lower threshold value were set at 101% and 99% respectively of the pre-fluctuation power output, in order to reach a determination as to whether there was a return to the vicinity of the pre-fluctuation power output, but the present invention is not limited to these, and values other than these values may be employed as the upper threshold value and the lower threshold value. Moreover, without varying the upper threshold value and the lower threshold value, the same value may be employed. For example, a power output which is the same as before the fluctuation may be employed as the common threshold value for the upper and lower side.

Furthermore, the upper threshold value and the lower threshold value may be modified to correspond to the size of the control initiating fluctuation amount. For example, when the control initiating fluctuation amount is set at 10% of the rated output, a threshold value in the range of 2% of the pre-fluctuation power output may be set as the threshold value (such that the upper threshold value and the lower threshold value are set at 102% and 98% respectively, of the pre-fluctuation power output). Moreover, it is preferable that the threshold values (the upper threshold value and the lower threshold value) be set within 20% of the control initiating fluctuation amount.

Moreover, the sampling period noted for the first and second embodiments, in regard to the specific values of the bus voltages and the like, they are not limited to these in this invention, and may be modified appropriately.

What is claims is:

1. A method of controlling a battery storing electric power generated by a power generator generating electric power using renewable energy, comprising:
computing a output value for electric power to be supplied to an electric power transmission system based on a predetermined maximum charge rate of the battery and a predetermined maximum discharge rate for the battery; and
supplying to the electric power transmission system electric power corresponding to the output value from at least one of the power generator and the battery.

2. The method of claim 1, wherein the output value is determined so that a continuous charge time and a continuous discharge time become substantially equal, the continuous charge time being a time required in order to completely charge the battery by the maximum charge rate from a particular point in time, and the continuous discharge time being a time required in order to completely discharge the battery by the maximum discharge rate at the point in time.

3. The method of claim 1, further comprising computing a target output value for the electric power based on the data on the electric power generated by the power generator, wherein the output value is determined so that the output value is lower than the target output value when a continuous charge time is longer than a continuous discharge time and that the output value is determined so that the output value is higher than the target output value when a continuous charge time is shorter than the continuous discharge time, the continuous charge time being a time required in order to completely charge the battery by the maximum charge rate from a particular point in time, and the continuous discharge time being a time required in order to completely discharge the battery by the maximum discharge rate at the point in time.

4. The method of claim 1, wherein the computation of the output value is performed when electric power generated by the power generator is greater than a predetermined generation value or when a fluctuation value of the electric power generated by the power generator is greater than a predetermined fluctuation value.

5. The method of claim 4, further comprising detecting regularly the electric power generated by the power generator so as to compute a target output value for the electric power, wherein a charge and discharge period charging and discharging the battery comprises detection periods in which the detection is performed, the detection periods include an initial period, a final period and intermediate periods between the initial and final periods, and the intermediate periods are shorter than the initial period or the final period.

6. A computer-readable recording medium which records a control programs for causing one or more computers to perform the steps comprising:
computing a continuous charging time at a certain time based on a predetermined maximum charge rate of the battery, the continuous charging time being a the time required to completely charge the battery at the maximum charging rate,
computing a continuous discharging time at the certain time based on a predetermined maximum discharge rate of the battery, the continuous discharging time being a time required to completely discharge the battery at the maximum discharging rate, computing a output value for the electric power to be supplied to an electric power transmission system, the output value being determined so that the continuous charging time and the continuous discharging time become substantially equal, and
supplying to the electric power transmission system electric power corresponding to the output value from at least one of the power generator and the battery.

7. The computer-readable recording medium of claim 6, the steps further comprise detecting a power output data at the certain time, the power output data being the amount of electric power generated by the power generator, and computing a target output value for the electric power based on the power output data, wherein the output value is determined so that the output value is lower than the target output value when a continuous charging time is longer than a continuous discharging time and that the output value is higher than the target output value when a continuous charging time is shorter than a continuous discharging time.

8. An electric power generation system, comprising:
a power generator configured to generate electric power using renewable energy;
a battery configured to store electric power generated by the power generator; and
a controller configured to compute a output value for the electric power to be supplied to an electric power transmission system based on a predetermined maximum charge rate of the battery and a predetermined maximum discharge rate for the battery, to supply to the electric power transmission system electric power corresponding to the output value from at least one of the power generator and the battery.

9. The electric power generation system of claim 8, wherein the controller is configured such that the output value is determined so that a continuous charging time and a continuous discharging time become substantially equal, the continuous charging time being a time required in order to completely charge the battery by the maximum charging rate from a particular point in time, and the continuous discharging time being a time required in order to completely discharge the battery by the maximum discharge rate at the point in time.

10. The electric power generation system of claim 8, wherein the controller is configured so that the electric power generated by the power generator is detected, that a target output value for the electric power is computed based on the detected electric power and that the output value is determined so that the output value is lower than the target output value when a continuous charging time is longer than a continuous discharging time and that the output value is higher than the target output value when a continuous charging time is shorter than a continuous discharging time.

11. An electric power generation system, comprising:
a power generator configured to generate electric power using renewable energy;
a battery configured to store electric power generated by the power generator;
a commutation section configured to compute an output value for the electric power to be supplied to an electric power transmission system based on a predetermined maximum charge rate of the battery and a predetermined maximum discharge rate of the battery; and
a supply section configured to supply to the electric power transmission system electric power corresponding to the output value from at least one of the power generator and the battery.

12. A device controlling a battery storing electric power generated by a power generator generating electric power using renewable energy, comprising:
a controller configured to compute a output value for the electric power to be supplied to an electric power transmission system based on a predetermined maximum charge rate of the battery and a predetermined maximum discharge rate of the battery, to supply to the electric power transmission system electric power corresponding to the output value from at least one of the power generator and the battery.
